(19) United States
(12) Patent Application Publication
(10) Pub. No.: US 2021/0078757 A1
(43) Pub. Date: Mar. 18, 2021

(54) LEAK PROOF CONTAINER WITH ADHESIVE ATTACHMENT

(71) Applicant: INTERNATIONAL PAPER COMPANY, Memphis, TN (US)

(72) Inventors: MARK ANTHONY WISECARVER, MORRISTOWN, TN (US); JAMES WILLIAM SLOAN, II, EDGEFIELD, SC (US); KENNETH CALVIN HYATT, SPRINGDALE, AR (US)

(21) Appl. No.: 16/572,768

(22) Filed: Sep. 17, 2019

(51) Int. Cl. B65D 5/42; B65D 5/24; B65D 5/28; B31B 70/00; B31B 70/04; B31B 70/26; B31B 70/62

(52) U.S. Cl. CPC B65D 5/4279; B65D 5/244; B65D 5/4266; B31B 70/62; B31B 70/006; B31B 70/04; B31B 70/26; B65D 5/28

(57) ABSTRACT

A leak proof container and a method of forming the container from a blank. The blank includes a bottom panel, first and second side panels connected to the bottom panel at opposing lateral edges, and first and second end portions located at opposing longitudinal ends of the blank. Each end portion includes an inner end panel connected to the bottom panel, an outer end panel connected to the inner end panel, and first and second corner panels forming gussets connected to a respective one of the first and second side panels and connected to the inner end panel. An adhesive area is located on one side of the blank and comprises at least a portion on each of the outer end panel and the inner end panel. The adhesive area adheres the gussets to the inner end panel and to the outer end panel.

### FIELD OF THE INVENTION

The present disclosure relates to containers or trays formed from a blank of material and, more particularly, to a container that is formed with a leak proof construction for retaining moisture or fluid within the container.

### BACKGROUND OF THE INVENTION

In some applications of containers or trays formed of folded material such as paperboard material, e.g., corrugated paperboard, the container or tray may be configured to receive products having moisture or a fluid content that can leak into a base portion of the container or tray. In a known use of a container, a package containing protein parts of poultry may be supported within the container and the container can prevent leakage of fluids outside of the container.

For example, one known type of container can be formed from a blank of corrugated material wherein a bottom panel and a plurality of side panels may be formed of a unitary construction from a die cut and scored sheet of material. It is also known to provide such a container construction wherein the corners adjacent to the bottom are sealed. In such a container construction, the side panels can be integrally connected to the bottom panel along respective fold lines, and adjacent side panels can be connected by a folded gusset or web that is disposed at each corner to essentially configure the corners as leak proof connections between panels. While such container constructions can facilitate containing and handing of food products, such as in a food processing plant, one known problem that may be associated with leakproof containers is the potential of foreign object contamination. For example, in production processes for corrugated container blanks configurated and used for forming current leakproof containers, there is potential for corrugated trim to remain attached to the container blank. Hence, there remains a possibility that trim debris may release from a container to contaminate the container contents, such as when containers are assembled manually or mechanically and/or when containers are positioned in close relation to each other as trim falls in between stacked containers during manufacturing, wherein the trim can find its way into assembled boxes filled with product.

### SUMMARY OF THE INVENTION

In accordance with an aspect of the invention, a blank for making a leak proof container is described. The blank comprises a bottom panel having a plurality of peripheral edges. First and second side panels are connected to the bottom panel at opposing lateral peripheral edges and define lower edges of the container. First and second end portions are located at opposing longitudinal ends of the blank. Each end portion includes an inner end panel connected to a longitudinal peripheral edge of the bottom panel, an outer end panel having an inner longitudinal edge hingedly connected to a longitudinal edge of the inner end panel, first and second corner panels, each corner panel having a longitudinal edge connected to a respective one of the first and second side panels and a lateral edge connected to a lateral edge of the inner end panel. An adhesive area is located on one side of the blank and comprises at least a portion on each of the outer end panel and the inner end panel.

The adhesive area may extend longitudinally generally continuously from the outer end panel to the inner end panel.

The adhesive area may comprise first and second laterally spaced adhesive areas.

The first and second adhesive areas may include outer lateral edges located adjacent to respective lateral edges of the outer end panels and adjacent to respective lateral edges of the inner end panels.

The adhesive areas may each include an inner lateral edge, parallel to the outer lateral edges of the adhesive areas, and an inner longitudinal edge having at least a portion defining an angled corner forming an obtuse angle extending from a respective inner lateral edge.

The first and second adhesive areas may extend longitudinally generally continuously from the outer end panel to the inner end panel.

The adhesive areas may be defined by an application of hot melt glue.

The corner panels may be formed as square panels, and may include a diagonal fold line dividing each corner panel into first and second triangular gusset panels.

Each corner panel may include a lateral edge that is colinear with a lateral edge of the blank defined by an edge of one of the first and second side panels.

A longitudinal dimension of the outer end panel may be substantially less than a longitudinal dimension of the inner end panel.

The adhesive area may be located on the outer side of the blank.

The adhesive area may be located on the inner side of the blank.

In accordance with another aspect of the invention, a container is provided including a bottom panel defining a bottom of the container and having a plurality of peripheral edges. First and second side panels are connected to the bottom panel at opposing lateral peripheral edges and folded upward relative to the bottom panel. First and second end portions are located at opposing longitudinal ends of the blank. Each end portion includes an inner end panel connected to a longitudinal peripheral edge of the bottom panel, an outer end panel having an inner longitudinal edge hingedly connected to a longitudinal edge of the inner end panel, first and second corner panels, each corner panel including longitudinal and lateral edges connected to respective edges of a side panel and the inner end panel, each corner panel folded about a diagonal gusset fold line to define a gusset, and each gusset folded perpendicular to a respective side panel to overlapping relationship with the inner end panel, First and second laterally spaced adhesive areas, comprising at least a portion of each of the areas located on each of the outer end panel and the inner end panel, wherein the outer end panel is folded about the inner longitudinal edge to overlapping relationship with at least a portion of each of the gussets.

The first and second adhesive areas may extend generally continuously from the outer end panel to the inner end panel.

Each adhesive area may extend between a respective gusset and the inner end panel to adhere the gussets to the inner end panel.

Each adhesive area may extend between a respective gusset and the outer end panel to adhere the gussets to the outer end panel.

The gusset fold line may extend from the bottom of the container to the inner longitudinal edge of the outer end panel.

The outer longitudinal edge of the outer end panel may be located in spaced relation from the bottom of the container.

The adhesive areas may be defined by an application of hot melt glue.

The gussets may be located in overlapping relationship with an outer side of the inner end panel.

The gussets may be located in overlapping relationship with an inner side of the inner end panel.

The adhesive areas may extend across substantially an entire area of the inner end panel that is overlapped by the gussets.

In accordance with a further aspect of the invention, a method of forming a container from a blank is provided. The blank comprises a bottom panel having a plurality of peripheral edges, first and second side panels connected to the bottom panel at opposing lateral peripheral edges and defining lower edges of the container, first and second end portions located at opposing longitudinal ends of the blank, each end portion including an inner end panel connected to a longitudinal peripheral edge of the bottom panel, an outer end panel having an inner longitudinal edge hingedly connected to a longitudinal edge of the inner end panel, first and second corner panels, each corner panel having a longitudinal edge connected to a respective one of the first and second side panels and a lateral edge connected to a lateral edge of the inner end panel. The method includes forming an end portion of the container comprising: applying an adhesive material to form an adhesive area located on the outer side of the blank and comprising at least a portion on each of the outer end panel and the inner end panel; folding the side panels and inner end panel upward from the bottom panel, and simultaneously folding each corner panel about a diagonal gusset fold line to define a gusset; folding each gusset perpendicular to a respective side panel to overlapping relationship with the inner end panel and into engagement with the adhesive area; and folding the outer end panel about the inner longitudinal edge of the outer end panel to position the adhesive area in engagement with at least a portion of each of the gussets.

The adhesive area may comprise first and second laterally spaced adhesive areas formed as strips adjacent to opposing lateral edges of the outer and inner end panels.

The first and second adhesive areas may extend generally continuously from the outer end panel to the inner end panel.

The adhesive area may be defined by an application of hot melt glue.

The gussets may be folded to overlapping relationship with an outer side of the inner end panel.

The gussets may be folded to overlapping relationship with an inner side of the inner end panel.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a plan view of a blank for forming a leak proof container;

FIG. 2 is a perspective view of an initial step in folding the blank to erect the leak proof container;

FIG. 3 is an elevation view illustrating a partially erected end portion and depicting a step of folding of gussets over an inner end panel;

FIG. 4 is a view similar to FIG. 3 illustrating an initial folding of an outer end panel toward overlapping relation with the gussets and the inner end panel; and

FIG. 5 is a perspective view of the erected leak proof container.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

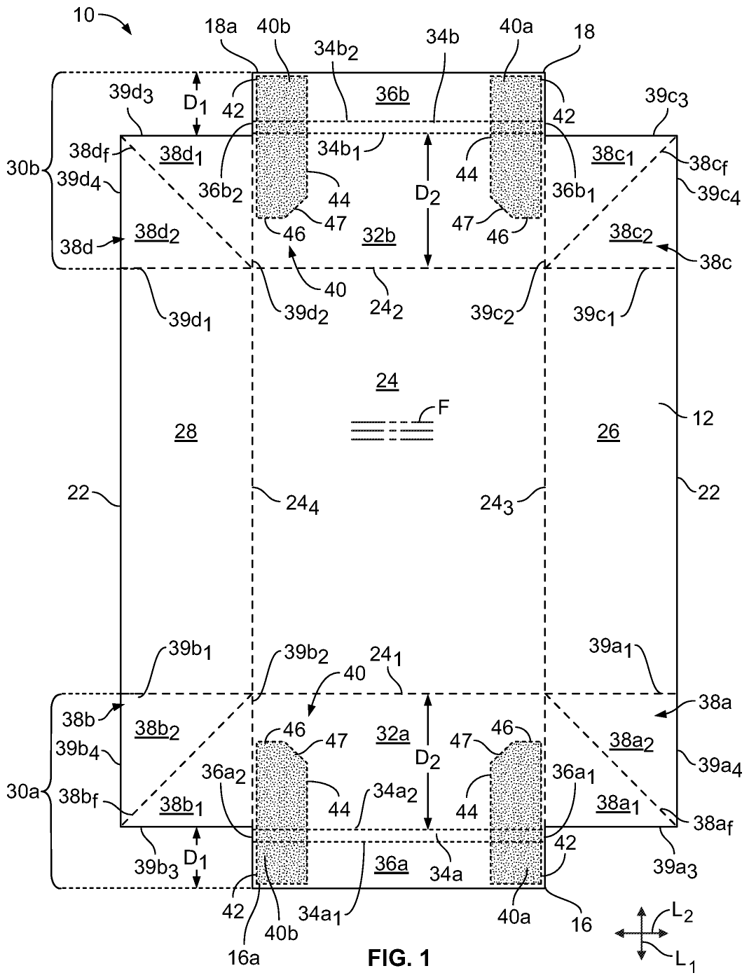

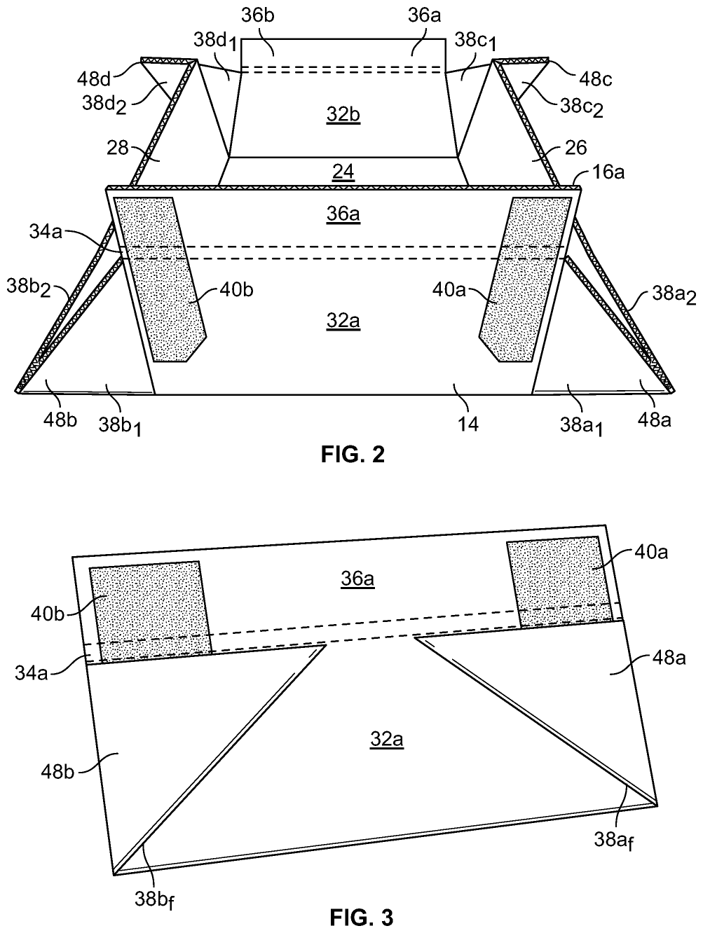

Referring to FIG. 1, a die cut blank 10 is shown for illustrating one or more aspects of a container or tray comprising a leak resistant container, as described herein. In a use of the blank 10 to form a one-piece leak proof container 8, see FIG. 5, the blank 10 may be formed of a corrugated cardboard material having an interior portion defined by elongated flutes, generally designated F in FIG. 1, as is generally known in the art, and may be die cut to the shape shown herein, although other materials and variations of the illustrated shape may be provided within the scope of the container described herein. The blank 10 illustrated in FIG. 1 is a planar piece of material in which an inner side 12 is shown facing out of the page and an outer side 14, see FIG. 2, faces in an opposite direction from the inner side 12.

As seen in FIG. 1, the blank 10 extends in a longitudinal direction L₁ between first and second longitudinal ends, generally designated 16 and 18, respectively, and further extends in a lateral direction L₂, perpendicular to the longitudinal direction L₁, between first and second lateral edges, generally designated 20 and 22, respectively. It may be noted that the flutes F extend in the lateral direction L₂.

The blank 10 comprises a bottom panel 24 having a plurality of peripheral edges 24₁, 24₂, 24₃, 24₄. A first side panel 26 is connected to the bottom panel 24 along a score line at the lateral peripheral edge 24₃, and a second side panel 28 is connected the bottom panel 24 along a score line at the opposing lateral peripheral edge 24₄. The peripheral edges 24₁, 24₂, 24₃, 24₄ define lower edges of the erected container 8.

First and second end portions 30a, 30b are located at the opposing longitudinal ends 16, 18 of the blank 10. Each end portion 30a, 30b includes a respective first and second inner end panels 32a, 32b connected to the longitudinal peripheral edges 24₁, 24₂ of the bottom panel 24 and extending between the lateral peripheral edges 24₃, 24₄. The first inner end panel 32a can include an outer longitudinal edge defined by a hinge portion 34a defined by a double score line 34a₁, 34a₂, and the second inner end panel 32b can include a hinge portion 34b defined by a double score line 34b₁, 34b₂. It should be understood that the inner end panels 32a, 32b may alternatively comprise hinge portions 34a, 34b defined by a single score line 34a₁, 34b₁.

The end portions 30a, 30b further include respective first and second outer end panels 36a, 36b. The first outer end panel 36a is hingedly joined to the first inner end panel 32a at the hinge portion 34a, and the second outer end panel 36b is hingedly joined to the second inner panel 32b at the hinge portion 34b. An inner longitudinal edge of the first outer end panel 36a can be connected to the first inner end panel 32a at the hinge portion 34a, and an outer longitudinal edge 16a of the first outer end panel 36a corresponds to the first longitudinal end 16 of the blank 10. An inner longitudinal edge of the second outer end panel 36b can be connected to the second inner end panel 32b at the hinge portion 34b, and an outer longitudinal edge 18a of the second outer end panel 36b corresponds to the second longitudinal end 18 of the blank 10. The first and second outer end panels 36a, 36b can be formed with a longitudinal dimension D₁ that is substantially less than a longitudinal dimension D₂ of the first and second inner end panels 32a, 32b.

The first end portion 30a additionally includes first and second corner panels 38a, 38b having inner longitudinal edges connected to the respective first and second side panels 26, 28 at score lines 39a₁, 39b₁ collinear with the longitudinal peripheral edge 24₁, and connected to the first inner end panel 32a at respective score lines 39a₂, 39b₂ collinear with the lateral peripheral edges 24₃, 24₄. The first and second corner panels 38a, 38b can each be formed with a square configuration having respective outer longitudinal edges 39a₃, 39b₃ collinear, or generally collinear with the outer longitudinal edge of the first inner end panel 32a, e.g., at the score line 34a₁, and having outer lateral edges 39a₄, 39b₄ collinear with the first and second lateral edges 20, 22, respectively. The first corner panel 38a additionally includes a score line defining a respective gusset fold line 38a_{f} extending diagonally across the corner panel 38a from an inner corner defined at an intersection of the score lines 39a₁ and 39a₂ to an intersection of the outer longitudinal edge 39a₃ and outer lateral edge 39a₄. Similarly, the second corner panel 38b additionally includes a score line defining a respective gusset fold line 38b_{f} extending diagonally across the corner panel 38b from an inner corner defined at an intersection of the score lines 39b₁ and 39b₂ to an intersection of the outer longitudinal edge 39b₃ and outer lateral edge 39b₄ The diagonal fold lines 38a_{f}, 38b_{f} divide the first and second corner panels 38a, 38b into first and second triangular gusset panels 38a₁, 38a₂ and 38b₁, 38b₂, respectively.

The second end portion 30b additionally includes first and second corner panels 38c, 38d having inner longitudinal edges connected to the respective first and second side panels 26, 28 at score lines 39c₁, 39d₁ collinear with the longitudinal peripheral edge 24₂, and connected to the first inner end panel 32b at respective score lines 39c₂, 39d₂ collinear with the lateral peripheral edges 24₃, 24₄. The first and second corner panels 38c, 38d can each be formed with a square configuration having respective outer longitudinal edges 39c₃, 39d₃ collinear, or generally collinear with the outer longitudinal edge of the second inner end panel 32b, e.g., at the score line 34b₁, and having outer lateral edges 39c₄, 39d₄ collinear with the first and second lateral edges 20, 22, respectively. The first corner panel 38c additionally includes a score line defining a respective gusset fold line 38c_{f} extending diagonally across the corner panel 38c from an inner corner defined at an intersection of the score lines 39c₁ and 39c₂ to an intersection of the outer longitudinal edge 39c₃ and outer lateral edge 39c₄. Similarly, the second corner panel 38d additionally includes a score line defining a respective gusset fold line 38d_{f} extending diagonally across the corner panel 38d from an inner corner defined at an intersection of the score lines 39d₁ and 39d₂ to an intersection of the outer longitudinal edge 39d₃ and outer lateral edge 39d₄ The diagonal fold lines 38c_{f}, 38d_{f} divide the first and second corner panels 38c, 38d into first and second triangular gusset panels 38c₁, 38c₂ and 38d₁, 38d₂, respectively.

Further, in accordance with an aspect for a machine erected container using the blank 10, each end portion 30a, 30b can include an adhesive area 40 associated with the outer side 14 of the blank 10. Referring to FIGS. 1 and 2, the adhesive area 40 at each end portion 30a, 30b can comprise first and second laterally spaced adhesive areas 40a, 40b that extend across at least a portion of respective outer and inner end panels 36a, 32a and 36b, 32b. In particular, each adhesive area 40a, 40b may comprise a strip of adhesive material extending from a longitudinal edge 16a, 18a on the outer side of a respective outer end panel 36a, 36b, and may extend to a location on a respective inner end panel 32a, 32b where a longitudinal inner edge 46 of the adhesive area 40a, 40b is spaced from a respective inner longitudinal edge of the inner end panel 32a, 32b, i.e., as defined at peripheral edges 24₁, 24₂. The adhesive areas 40a, 40b extend continuously, or generally continuously, longitudinally from the outer end panel 36a, 36b to the inner end panel 32a, 32b.

As is exemplified by the adhesive areas 40a, 40b on the first end portion 30a, each adhesive area 40a, 40b includes an outer lateral edge 42 located adjacent to respective lateral edges 36a₁, 36a₂ of the outer end panel 36a, and located adjacent to respective lateral edges of the first inner end panel 32a, i.e., at the score lines 39a₂, 39b₂. The adhesive areas 40a, 40b further include respective inner lateral edges 44 that may be parallel or generally parallel to the outer lateral edges 42. Similarly, the adhesive areas 40a, 40b on the second end portion 30b are located adjacent to lateral edges 36b₁, 36b₂ of the second outer end panel 36b, and located adjacent to respective lateral edges of the inner end panel 32b, i.e., at the score lines 39c₂, 39d₂.

Each adhesive area 40a, 40b can include an angled corner 47 defined between the inner longitudinal edge 46 of each adhesive area 40a, 40b and a respective inner lateral edge 44. The angled corner 47 forms an obtuse angle extending from the inner lateral edge 44. However, it should be understood that the adhesive area 40, e.g., the adhesive areas 40a, 40b, may cover additional or less area, and may have other shapes, than is described and illustrated herein. For example, and without limitation, the adhesive area 40 may extend across substantially the entire lateral area of the outer end panel 36a, 36b, and may extend over substantially an entire area of the inner end panel 32a, 32b that is overlapped by gussets formed by the corner panels 38a, 38b, 38c, 38d, as is described further below.

Referring to FIGS. 2-5 a method of forming the blank 10 into an erected container 8 is described, wherein it should be understood that the method of forming the erected container 8 may be machine implemented, as is facilitated by the described configuration for the blank 10. Additionally, it may be noted that the machine implemented forming operation can include providing the adhesive area 40 as an application of hot melt glue applied as a final step in forming or preparing the blank 10, which can also comprise an initial step of the container forming operation.

The side panels 26, 28 and inner end panels 32a, 32b are initially folded upward from the bottom panel 24. Simultaneously, the corner panels 38a, 38b, 38c, 38d can be folded about respective gusset fold lines 38a_{f}, 38b_{f}, 38c_{f}, 38d_{f} to define gussets 48a, 48b, 48c, 48d, see FIG. 2, and the gussets 48a, 48b, 48c, 48d can be folded perpendicular to a respective side panel 26, 28 into overlapping relationship with an inner end panel 32a, 32b, as illustrated by gussets 48a, 48b in overlapping relationship with the inner end panel 32a in FIG. 3, it being understood that a similar operation can be performed, either simultaneously or subsequently, at the opposing end portion 30b to position the gussets 48c, 48d in overlapping relationship with the inner end panel 32b. As the gussets 48a, 48b, 48c, 48c are folded into overlapping relationship with the inner end panels 32a, 32b, the gussets 48a, 48b, 48c, 48d are also brought into engagement with the portion of the adhesive area 40, e.g., the adhesive areas 40a, 40b, on the inner end panels 32a, 32b to retain the gussets 48a, 48b, 48c, 48d in engagement on the inner end panels 32a, 32b. The angled corners 47 of the adhesive areas 40a, 40b can provide a contour of the adhesive areas 40a, 40b that is generally parallel to and closely adjacent to respective gusset fold lines 38a_{f}, 38b_{f}, 38c_{f}, 38d_{f}.

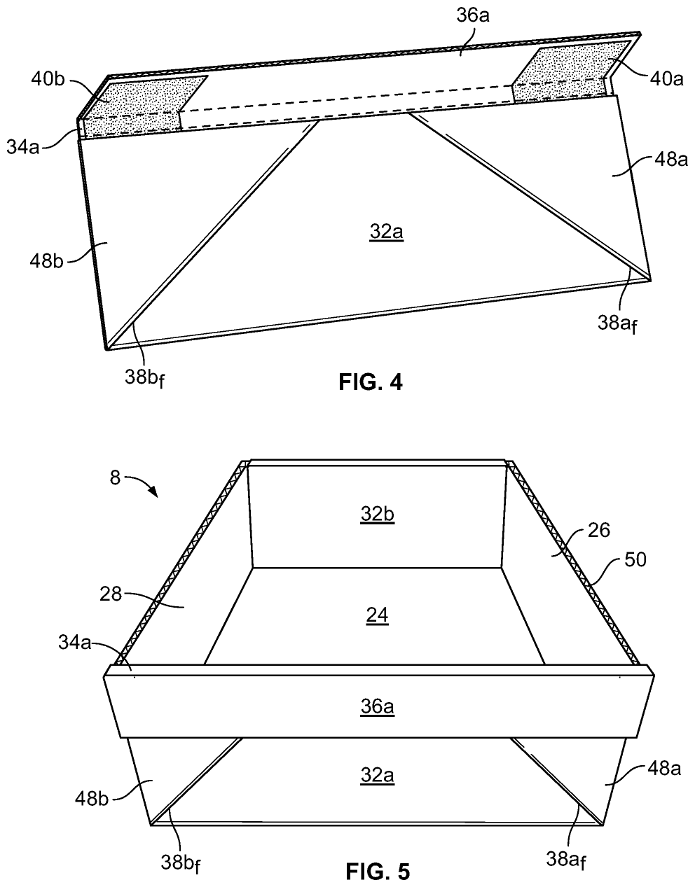

The outer end panels 36a, 36b are subsequently pivoted outwardly about the inner longitudinal edge, i.e., at the hinge portions 34a, 34b, as is illustrated by the partially pivoted outer end panel 36a in FIG. 4. Pivoting or folding the outer end panels 36a, 36b positions the outer end panels 36a, 36b in overlapping relationship over the respective gussets 48a, 48b, 48c, 48d, and positions the adhesive area 40 on the outer end panels 36a, 36b in engagement with at least a portion of the gussets 48a, 48b, 48c, 48d to further secure the gussets 48a, 48b, 48c, 48d in position and form a rigid structure for the ends of the container 8, as seen in FIG. 5. Hence, providing the adhesive area 40 as a continuous area extending from the outer end panel 36a, 36b to the inner end panel 32a, 32b provides an efficient application of adhesive that is used to adhere the gussets 48a, 48b, 48c, 48d to both the inner and outer end panels 32b, 32a and 36a, 36b.

The configuration formed by the folded gussets 48a, 48b, 48c, 48d defines folded container corners that form a continuous connection between the side panels 26, 28 and the inner end panels 32a, 32b extending from the bottom panel 24 to an upper edge 50, see FIG. 5, of the container 8. Hence, the continuous configuration formed by the gussets 48a, 48b, 48c, 48d can prevent or substantially limit fluids from leaking out of the container 8 at junctions between the side panels 26, 28 and the inner end panels 32a, 32b.

It may be noted that the outer longitudinal edges 16a, 18a of the outer end panels 36a, 36b may be located in vertically spaced relation from the bottom 24 of the container, i.e., the peripheral edges 24₁, 24₂. For example, the outer end panels 36a, 36b may extend less than approximately half-way down the inner end panels 32a, 32b to reduce the material required for the outer end panel material. That is, the dimension D₁ can be less than half the dimension D₂, see FIG. 1.

The inner end panel 32b, outer end panel 36b, and gussets 48c, 48d forming the opposing end of the container 8 can be folded in manner similar to that described above for the inner end panel 32a, outer end panel 36a, and gussets 48a, 48b to form the completed container 8, as illustrated in FIG. 5. While the described blank 10 and container 8 provides a configuration that can be readily assembled in a machine implemented folding operation, it may be understood that the blank 10 can also be erected into the container utilizing a manual operation or a combination of machine and manual implemented operations. Also, it should be understood that, although a hot melt glue is described as an adhesive for the adhesive area 40, other adhesive materials may be provided for the adhesive area 40.

Also, it should be noted that, although the described construction of the container presents the gussets 48a, 48b, 48c, 48d being folded outward of the container, the gussets 48a, 48b, 48c, 48d may alternatively be folded inward to overlap respective inner sides of the inner end panels 32a, 32b and the outer end panels 36a, 36b may be folded inward. In such an alternative folding operation, the adhesive area 40 would be applied to the inner surface 12 of the inner and outer end panels 32b, 32a and 36a, 36b.

It may be understood that, the blank 10 described herein may be formed having a clean outside perimeter, with straight cuts, including straight common knife areas, and no internal trim areas, without additional features such as cutouts or slots, such that the potential for trim debris created from such cutouts or slots is avoided. Hence, the configuration of the blank 10 and resulting container 8 can provide a container for food products that can avoid or substantially reduce contamination as a result of eliminating internal scrap areas, for example, eliminating the release of debris from the blank structure and/or when scrap is released but falls in between plural containers as they are stacked or otherwise grouped together.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A blank for making a leak proof container, the blank having an inner side and an outer side and comprising:
a bottom panel having a plurality of peripheral edges;
first and second side panels connected to the bottom panel at opposing lateral peripheral edges and defining lower edges of the container;
first and second end portions located at opposing longitudinal ends of the blank, each end portion including:
an inner end panel connected to a longitudinal peripheral edge of the bottom panel;
an outer end panel having an inner longitudinal edge hingedly connected to a longitudinal edge of the inner end panel;
first and second corner panels, each corner panel having a longitudinal edge connected to a respective one of the first and second side panels and a lateral edge connected to a lateral edge of the inner end panel; and
an adhesive area located on one side of the blank and comprising at least a portion on each of the outer end panel and the inner end panel, wherein the adhesive area extends longitudinally generally continuously from the outer end panel to the inner end panel.

2. (canceled)

3. The blank as set forth in claim 1, wherein the adhesive area comprises first and second laterally spaced adhesive areas.

4. The blank as set forth in claim 3, wherein the first and second adhesive areas include outer lateral edges located adjacent to respective lateral edges of the outer end panels and adjacent to respective lateral edges of the inner end panels.

5. The blank as set forth in claim 4, wherein the adhesive areas each include an inner lateral edge, parallel to the outer lateral edges of the adhesive areas, and an inner longitudinal edge having at least a portion defining an angled corner forming an obtuse angle extending from a respective inner lateral edge.

6. The blank as set forth in claim 3, wherein the first and second adhesive areas extend longitudinally generally continuously from the outer end panel to the inner end panel.

7. The blank as set forth in claim 3, wherein the adhesive areas are defined by an application of hot melt glue.

8. The blank as set forth in claim 1, wherein the corner panels are formed as square panels, and including a diagonal fold line dividing each corner panel into first and second triangular gusset panels.

9. The blank as set forth in claim 8, wherein each corner panel includes a lateral edge that is colinear with a lateral edge of the blank defined by an edge of one of the first and second side panels.

10. The blank as set forth in claim 1, wherein a longitudinal dimension of the outer end panel is substantially less than a longitudinal dimension of the inner end panel.

11. The blank as set forth in claim 1, wherein the adhesive area is located on the outer side of the blank.

12. The blank as set forth in claim 1, wherein the adhesive area is located on the inner side of the blank.

13. A container including a bottom panel defining a bottom of the container and having a plurality of peripheral edges, first and second side panels connected to the bottom panel at opposing lateral peripheral edges and folded upward relative to the bottom panel, first and second end portions located at opposing longitudinal ends of the blank, each end portion including:
an inner end panel connected to a longitudinal peripheral edge of the bottom panel;
an outer end panel having an inner longitudinal edge hingedly connected to a longitudinal edge of the inner end panel;
first and second corner panels, each corner panel including longitudinal and lateral edges connected to respective edges of a side panel and the inner end panel, each corner panel folded about a diagonal gusset fold line to define a gusset, and each gusset folded perpendicular to a respective side panel to overlapping relationship with the inner end panel;
first and second laterally spaced adhesive areas comprising at least a portion of each of the areas located on each of the outer end panel and the inner end panel, and wherein the first and second adhesive areas extend generally continuously from the outer end panel to the inner end panel; and
wherein the outer end panel is folded about the inner longitudinal edge to overlapping relationship with at least a portion of each of the gussets.

14. (canceled)

15. The container as set forth in claim 13, wherein each adhesive area extends between a respective gusset and the inner end panel to adhere the gussets to the inner end panel.

16. The container as set forth in claim 15, wherein each adhesive area extends between a respective gusset and the outer end panel to adhere the gussets to the outer end panel.

17. The container as set forth in claim 13, wherein the gusset fold line extends from the bottom of the container to the inner longitudinal edge of the outer end panel.

18. The container as set forth in claim 13, wherein the outer longitudinal edge of the outer end panel is located in spaced relation from the bottom of the container.

19. The container as set forth in claim 13, wherein the adhesive areas are defined by an application of hot melt glue.

20. The container as set forth in claim 13, wherein the gussets are located in overlapping relationship with an outer side of the inner end panel.

21. The container as set forth in claim 13, wherein the gussets are located in overlapping relationship with an inner side of the inner end panel.

22. The container as set forth in claim 13, wherein the adhesive areas extend across substantially an entire area of the inner end panel that is overlapped by the gussets.

23. A method of forming a container from a blank having an inner and outer side, the blank comprising a bottom panel having a plurality of peripheral edges, first and second side panels connected to the bottom panel at opposing lateral peripheral edges and defining lower edges of the container, first and second end portions located at opposing longitudinal ends of the blank, each end portion including an inner end panel connected to a longitudinal peripheral edge of the bottom panel, an outer end panel having an inner longitudinal edge hingedly connected to a longitudinal edge of the inner end panel, first and second corner panels, each corner panel having a longitudinal edge connected to a respective one of the first and second side panels and a lateral edge connected to a lateral edge of the inner end panel, the method including forming an end portion of the container comprising:
applying an adhesive material to form an adhesive area located on the outer side of the blank and comprising at least a portion on each of the outer end panel and the inner end panel;
folding the side panels and inner end panel upward from the bottom panel, and simultaneously folding each corner panel about a diagonal gusset fold line to define a gusset;
folding each gusset perpendicular to a respective side panel to overlapping relationship with the inner end panel and into engagement with the adhesive area; and
folding the outer end panel about the inner longitudinal edge of the outer end panel to position the adhesive area in engagement with at least a portion of each of the gussets.

24. The method as set forth in claim 23, wherein the adhesive area comprises first and second laterally spaced adhesive areas formed as strips adjacent to opposing lateral edges of the outer and inner end panels.

25. The method as set forth in claim 24, wherein the first and second adhesive areas extend generally continuously from the outer end panel to the inner end panel.

26. The method as set forth in claim 23, wherein the adhesive area is defined by an application of hot melt glue.

27. The method as set forth in claim 23, wherein the gussets are folded to overlapping relationship with an outer side of the inner end panel.

28. The method as set forth in claim 23, wherein the gussets are folded to overlapping relationship with an inner side of the inner end panel.
